(19) United States
(12) Patent Application Publication
(10) Pub. No.: US 2024/0412125 A1
(43) Pub. Date: Dec. 12, 2024

(54) MULTI-DIMENSIONAL SKILLS MODEL

(71) Applicant: INTERNATIONAL BUSINESS MACHINES CORPORATION, Armonk, NY (US)

(72) Inventors: CherylAnne G. Howard, FALLS CHURCH, VA (US); Maureen Fitzgerald Norton, Avon, CT (US); Jonathan D. Dunne, Dungarvan (IE); Slobodan Radenkovic, Malinovo (SK)

(21) Appl. No.: 18/206,276

(22) Filed: Jun. 6, 2023

(51) Int. Cl. G06Q 10/0631

(52) U.S. Cl. CPC G06Q 10/063112

(57) ABSTRACT

A system, method, and computer program product are configured to: analyze, based on a taxonomy of skills, a plurality of data sources to determine skills of a position, skills of an individual, and trend skills of a profession; create, based on the analyzing, a multi-dimensional skills model comprising a first axis corresponding to the skills of the individual, a second axis corresponding to the skills of the position, and a third axis corresponding to the trend skills of the profession; and determine, using the multi-dimensional skills model, a score of a comparison of the skills of the individual to the skills of the position.

### BACKGROUND

Aspects of the present invention relate generally to computer-based modeling and, more particularly, to systems and methods for creating and using a multi-dimensional skills model.

As businesses look to retain and recruit individuals in emerging or key professions, of core value are the skills that underpin the profession. Different professions have different skill sets. For example, looking at the Data Science profession, there are many skills that can be attached to the profession, including statistical methods, machine learning, and natural language processing, to name but a few.

### SUMMARY

In a first aspect of the invention, there is a computer-implemented method including: analyzing, by a processor set, a plurality of data sources to determine skills of a position, skills of an individual, and trend skills of a profession; creating, by the processor set and based on the analyzing, a multi-dimensional skills model comprising a first axis corresponding to the skills of the individual, a second axis corresponding to the skills of the position, and a third axis corresponding to the trend skills of the profession; and determining, by the processor set and using the multi-dimensional skills model, a score of a comparison of the skills of the individual to the skills of the position.

In another aspect of the invention, there is a computer program product including one or more computer readable storage media having program instructions collectively stored on the one or more computer readable storage media. The program instructions are executable to: analyze, based on a taxonomy of skills, a plurality of data sources to determine skills of a position, skills of an individual, and trend skills of a profession; create, based on the analyzing, a multi-dimensional skills model comprising a first axis corresponding to the skills of the individual, a second axis corresponding to the skills of the position, and a third axis corresponding to the trend skills of the profession; and determine, using the multi-dimensional skills model, a score of a comparison of the skills of the individual to the skills of the position.

In another aspect of the invention, there is a system including a processor set, one or more computer readable storage media, and program instructions collectively stored on the one or more computer readable storage media. The program instructions are executable to: analyze, based on a taxonomy of skills, a plurality of data sources to determine skills of a position, skills of an individual, and trend skills of a profession; create, based on the analyzing, a multi-dimensional skills model comprising a first axis corresponding to the skills of the individual, a second axis corresponding to the skills of the position, and a third axis corresponding to the trend skills of the profession; and determine, using the multi-dimensional skills model, a score of a comparison of the skills of the individual to the skills of the position.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a portion of an exemplary hierarchical taxonomy in accordance with aspects of the present invention.

FIG. 4 shows an exemplary multi-dimensional skills model in accordance with aspects of the present invention.

FIG. 5 shows an example of generalizing a multi-dimensional skills model across plural professions in accordance with aspects of the present invention.

FIG. 6 shows a flowchart of an exemplary method in accordance with aspects of the present invention.

### DETAILED DESCRIPTION

Aspects of the present invention relate generally to computer modeling and, more particularly, to systems and methods for creating and using a multi-dimensional skills model. Embodiments of the invention include analyzing skills of a profession, skills of an individual, and current trends in skills of the profession. A multi-dimensional skills model is derived based on this analysis. In embodiments, the multi-dimensional skills model is used for optimal recruitment of new individuals and optimal growth of current individuals. The multi-dimensional skills model may be generalized across different professions, such as Data Science, Finance, Sales, etc.

Hiring managers have a number of challenges when wishing to fill a position. A first challenge lies in the relationship and taxonomy of skills that underpin the profession related to the position. A second challenge is mapping the skills to levels of experience. A third challenge lies in the mercurial nature of the skills required in the marketplace based on current trends.

Existing recruitment and retention techniques do not reconcile skills of a profession, skills of an individual, and current trends in skills of the profession. As a result, existing recruitment and retention techniques are incapable of providing a single model that can be used for both optimizing recruitment of new individuals into an organization and optimizing growth of current individuals already in the organization. Implementations of the invention address these problems by providing a multi-dimensional skills model that can be used to accomplish both optimizing recruitment of new individuals into an organization and optimizing growth of current individuals already in the organization. Implementations of the invention build the novel multi-dimensional skills model using computer-based techniques that cannot be performed mentally, such as topic modeling and corpus linguistics. In this manner, implementations of the invention provide a technical improvement in the fields of computer-based modeling and recruitment and retention.

In accordance with aspects of the invention, there is a computer-implemented method, system, and computer program product for multi-dimensional skills modeling, where the computer-implemented method, system, and computer program product are configured to: analyze a plurality of data sources to determine profession skills, individual skill levels, and current profession trends; generate, based on the analysis, a multi-dimensional skills model that includes time-series forecasting, topic modeling, and corpus linguistics, wherein an x-axis of the multi-dimensional skills model is associated with a list of hierarchical skills of a job candidate and their efficacy, a y-axis of the multi-dimensional skills model is associated with a list of skills for a current job position, and a z-axis of the multi-dimensional skills model is associated with a list of future forecast domain skills based on existing market trends; and determine, based on the multi-dimensional skills model: (i) optimal candidates for the current job position and/or (ii) a probability for a job candidate to move to a new job domain.

It should be understood that, to the extent implementations of the invention collect, store, or employ personal information provided by, or obtained from, individuals (for example, curriculum vitae information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as multi-dimensional skills modeling code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

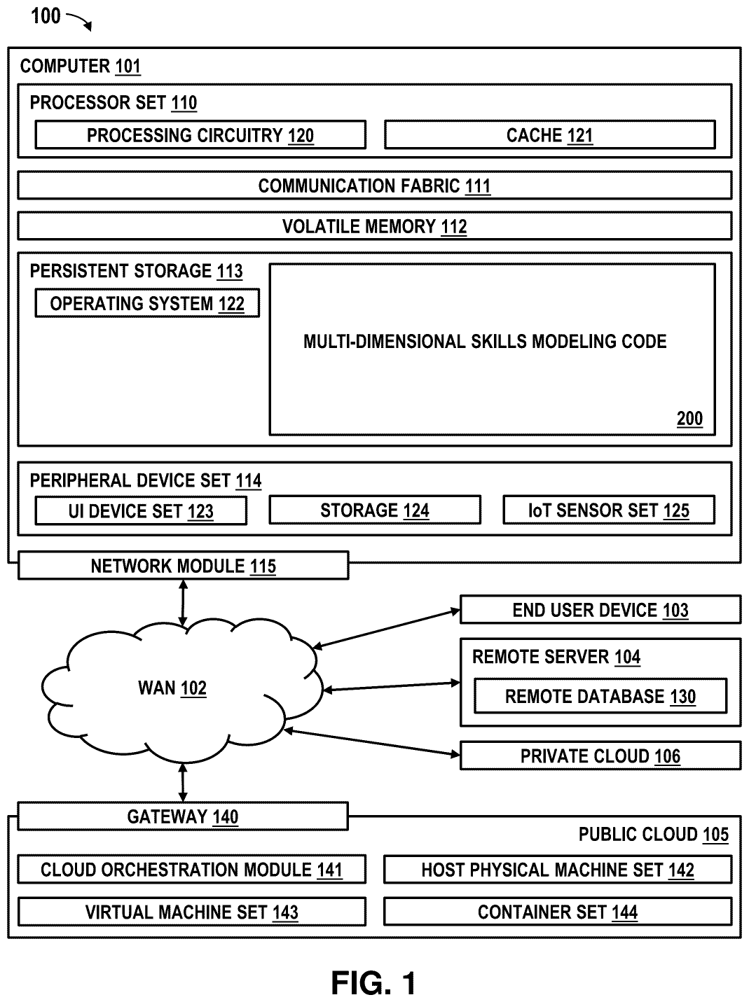

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

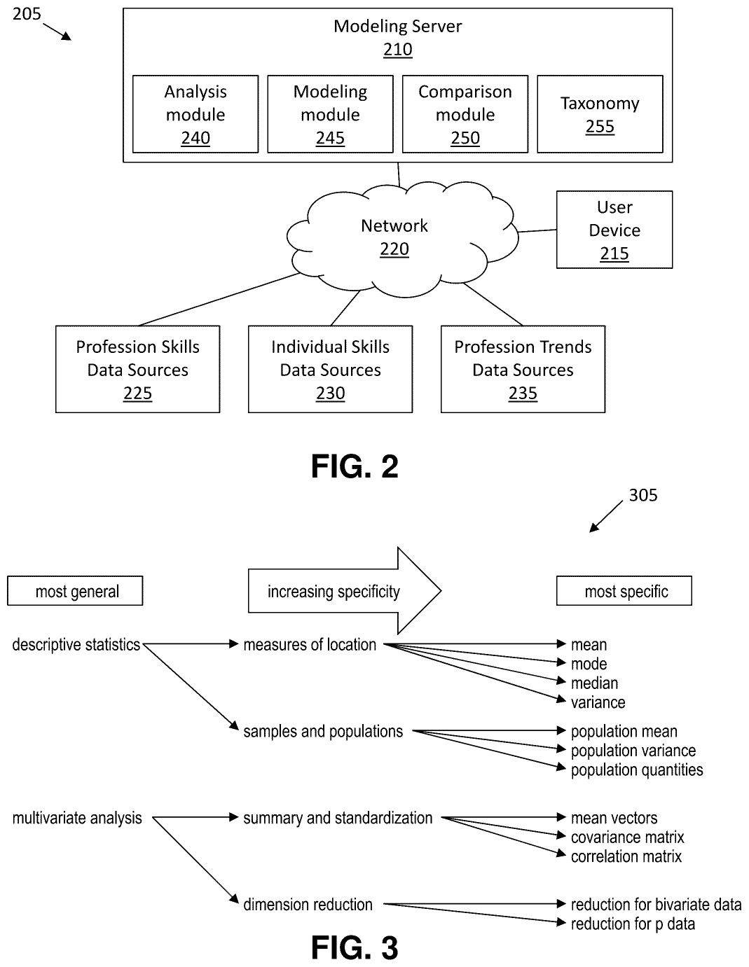

FIG. 2 shows a block diagram of an exemplary environment 205 in accordance with aspects of the invention. In embodiments, the environment 205 includes a modeling server 210 in communication with a user device 215 via a network 220. In one example, the modeling server 210 comprises one or more instances of the computer 101 of FIG. 1. In another example, the modeling server 210 comprises one or more virtual machines or one or more containers running on one or more instances of the computer 101 of FIG. 1. The user device 215 may comprise one or more instances of the EUD 103 of FIG. 1. The network 220 may comprise one or more networks such as the WAN 102 of FIG. 1.

In embodiments, the modeling server 210 of FIG. 2 comprises an analysis module 240, a modeling module 245, and a comparison module 250, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The modeling server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

With continued reference to FIG. 2, the environment 205 includes one or more profession skills data sources 225, one or more individual skills data sources 230, and one or more professions trends data sources 235. In embodiments, each of the data sources 225, 230, and 235 comprises information (e.g., one or more documents) stored on one or more computing devices that are accessible by the modeling server 210 via the network 220. The one or more computing devices may comprise an EUD 103 of FIG. 1, remote server 104 of FIG. 1, private cloud 106 of FIG. 1, or other types of computing devices capable of storing documents and making the documents accessible via the network 220.

In embodiments, the profession skills data sources 225 comprise one or more documents that contain information that describes a position within a profession. The position may comprise a job for which an organization is hiring. For example, the documents may comprise a public job posting or an internal job specification that lists or describes topics including one or more of: duties performed in the position, educational requirements of the position, work experience requirements of the position, how candidates will be evaluated for the position, etc. Such documents contain information that can be analyzed by the server 210 to determine skills associated with the position.

In embodiments, the individual skills data sources 230 comprise one or more documents associated with an individual. The individual may be a candidate for a position (e.g., in a recruitment scenario) or may be an existing team member (e.g., in a retention or growth scenario), for example. The documents may comprise one or more of: a curriculum vitae (e.g., résumé) of the individual, published papers of which the individual is an author or co-author, patents of which the individual is an inventor or co-inventor. Such documents contain information that can be analyzed by the server 210 to determine skills possessed by this individual.

In embodiments, the profession trends data sources 235 comprise one or more documents that contain information about a profession. The documents may comprise academic papers published about topics in the profession. For example, these documents may describe research performed in the profession. Such documents contain information that can be analyzed by the server 210 to determine current profession trends.

In accordance with aspects of the invention, the analysis module 240 of the modeling server 210 is configured to analyze the profession skills data sources 225, the individual skills data sources 230, and the profession trends data sources 235 to identify skills from a taxonomy 255 that are mentioned or described in these data sources 225, 230, and 235. In embodiments, the taxonomy 255 comprises a hierarchical taxonomy of skills associated with a profession (e.g., Data Science, Finance, Sales, etc.). The taxonomy 255 may be predefined (e.g., developed by one or more subject matter experts) and stored at or accessible by the server 210. In embodiments, the analysis module 240 uses topic modeling and corpus linguistics to analyze the profession skills data sources 225, the individual skills data sources 230, and the profession trends data sources 235 to identify skills that are included in the taxonomy 255 and that are mentioned or described in these data sources 225, 230, and 235. Topic modeling is an unsupervised machine learning technique that is capable of scanning a set of documents, detecting word and phrase patterns within them, and automatically clustering word groups and similar expressions that best characterize a set of documents. Corpus linguistics is a methodology that involves computer-based empirical analyses (both quantitative and qualitative) of language use by employing large, electronically available collections of naturally occurring spoken and written texts, so-called corpora.

For example, the analysis module 240 analyzes the profession skills data sources 225 to identify one or more skills from the taxonomy 255 that are mentioned or described in the documents of the profession skills data sources 225. In this manner, the analysis module 240 determines one or more skills of the taxonomy 255 that are associated with a position (e.g., job). The set of skills identified in this manner may be referred to as skills of a position.

Similarly, the analysis module 240 analyzes the individual skills data sources 230 to identify one or more skills from the taxonomy 255 that are mentioned or described in the documents of the individual skills data sources 230. In this manner, the analysis module 240 determines one or more skills of the taxonomy 255 that are associated with an individual. The set of skills identified in this manner may be referred to as skills of an individual.

Similarly, the analysis module 240 analyzes the profession trends data sources 235 to identify one or more skills from the taxonomy 255 that are mentioned or described in the documents of the profession trends data sources 235. In this manner, the analysis module 240 determines one or more skills of the taxonomy 255 that are associated with a profession.

In accordance with aspects of the invention, the analysis module 240 uses times series forecasting with skills identified from the profession trends data sources 235 to predict skills associated with a profession at future points in time. In embodiments, the profession trends data sources 235 include academic papers that are published at different dates. In embodiments, the analysis module 240 identifies skills from the taxonomy that are mentioned or described by these papers at different dates. The identified skills and their dates comprise time series data, and the analysis module 240 uses times series forecasting with this time series data to predict skills from the taxonomy that will be associated with this profession at future dates. The set of skills identified in this manner may be referred to as trend skills of a profession.

The identified skills of the position, skills of an individual, and trend skills of a profession represent three respective subsets of skills included in the taxonomy 255. It is possible that two or three of the subsets will be identical; however, this is highly unlikely since a taxonomy may have hundreds of skills.

In accordance with aspects of the invention, the modeling module 245 creates a multi-dimensional skills model based on the sets of skills identified in each of the data sources 225, 230, and 235. In embodiments, the multi-dimensional skills model comprises an x-axis, a y-axis, and a z-axis in a three-dimensional (3D) space. In embodiments, the x-axis comprises the skills of the individual determined by analyzing the individual skills data sources 230 as described herein, the y-axis comprises the skills of the position determined by analyzing the profession skills data sources 225 as described herein, and the z-axis comprises the trend skills of the profession determined by analyzing the profession trends data sources 235 as described herein. In embodiments, the multi-dimensional skills model contains an array of integers that map the co-occurrence of collocating terms in a text corpus (e.g., the taxonomy 255) based on one or more of: topic bundles, log likelihood, term frequency, bigram count, trigram count, date (e.g., year, month, day), and skill frequency count. The modeling module 245 may convert the respective sets of skills determined from the respective data sources into integer arrays using an algorithm such as word2vec.

In accordance with aspects of the invention, the comparison module 250 uses the multi-dimensional skills model to compare the skills of the individual to the skills of the position. In embodiments, the comparison module 250 compares the skills of the individual to the skills of the position by determining a score based on a distance between: (i) the skills of the individual plotted in the multi-dimensional skills model and (ii) the skills of the position plotted in the multi-dimensional skills model. In embodiments, the comparison module 250 determines the score using an algorithm such as Cohen's kappa, cosine similarity, or Euclidean distance based on k-means clustering. In one example using Cohen's kappa, the comparison module 250 determines a probability score between 0 and 1, with higher scores meaning that the individual is more fit for this position and lower scores meaning the individual is less fit for this position. In another example using a Euclidean distance determined using clustering, the determined score quantifies how far away this individual's skills are from the skills of the position, with a higher value of distance being further away a lower value of distance being closer. In both examples, the score can be used to evaluate the individual's fitness for the position, e.g., in a recruitment scenario or in the scenario of an individual moving to a new profession based on their existing skill eminence.

In accordance with aspects of the invention, the comparison module 250 uses the multi-dimensional skills model to compare the skills of the individual to the trend skills of the profession. In embodiments, the comparison module 250 compares the skills of the individual to the trend skills of the profession by determining a score based on a distance between: (i) the skills of the individual plotted in the multi-dimensional skills model and (ii) the trend skills of the profession plotted in the multi-dimensional skills model. In embodiments, the comparison module 250 determines a score using an algorithm such as Cohen's kappa, cosine similarity, or Euclidean distance based on k-means clustering, e.g., in a manner similar to that described above for the skills of the position. The score can be used to determine areas of growth for the individual.

FIG. 3 shows a portion of an exemplary hierarchical taxonomy 305 in accordance with aspects of the present invention. The taxonomy 305 is an example of a taxonomy 255 used by the modeling server 210 as described at FIG. 2. In this example, the taxonomy 305 includes skills associated with a Data Science profession. In this example, the taxonomy 305 is hierarchical in that it includes most general terms at a first layer, most specific terms at a last layer, and terms of increasing specificity in one or more layers between the first layer and the last layer. In an example operation using the taxonomy 305, the analysis module 240 of FIG. 2 analyzes each of the data sources 225, 230, and 235 for mentions or descriptions of the terms in the taxonomy 305. The example shown in FIG. 3 is not limiting, and other taxonomies having different numbers of layers and different terms may be used for different professions. Taxonomies may have hundreds of different skills. For example, an exemplary hierarchical taxonomy for the Data Science profession has over eight hundred different skills.

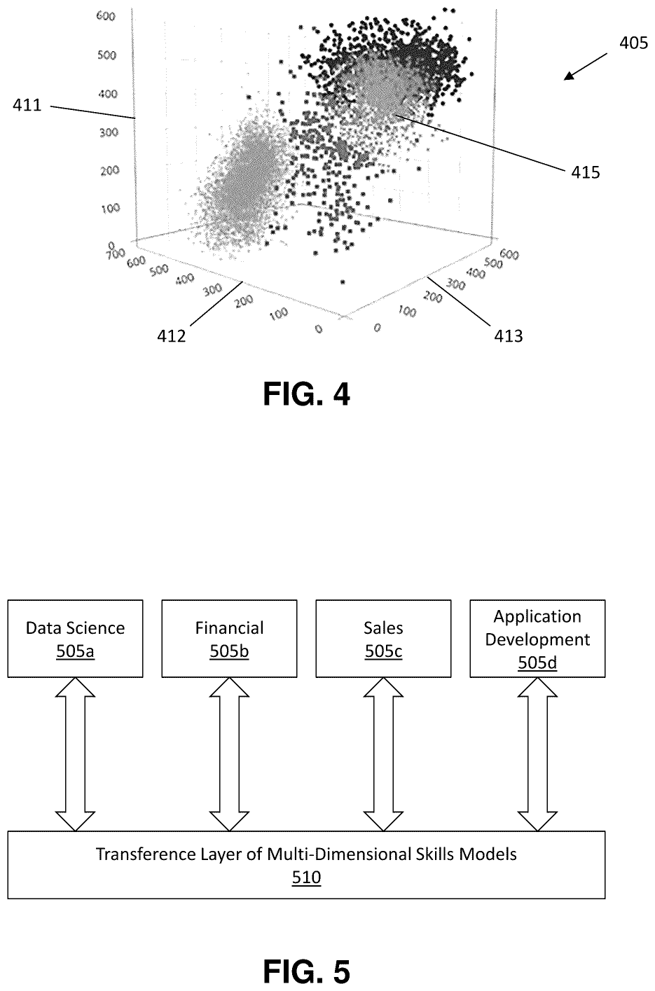

FIG. 4 shows an exemplary multi-dimensional skills model 405 in accordance with aspects of the present invention. In this example, the model 405 includes an x-axis 411 associated with the skills of the individual determined by analyzing the individual skills data sources 230, a y-axis 412 associated with the skills of a position determined by analyzing the profession skills data sources 225, and a z-axis 413 associated with a list of trend skills of the profession determined by analyzing the profession trends data sources 235. In this example, the model 405 includes data points 415 mapped into the 3D space according to the axes 411, 412, and 413, where the data points correspond to the respective skills identified from the respective data sources 225, 230, and 235.

In one exemplary implementation, the multi-dimensional skills model 405 is created for one individual and one position in a profession. In this implementation, the multi-dimensional skills model 405 may be used to determine a probability score that the skills of the individual are fit for the position. The probability score may be determined using a Cohen's kappa algorithm based on the data plotted in the multi-dimensional skills model. For example, this score may be used by an organization for evaluating a single candidate for a position with the organization, e.g., in a recruitment scenario, by determining the score based on the distance between the skills of the individual and the skills of the position. In another example, this score may be used by an individual for evaluating their fitness for moving to a new profession, e.g., by determining the score based on a distance between their skills in the new profession and skills of the position in the new profession. In another example, this score may be used by an individual for planning growth, e.g., by determining the score based on a distance between their skills in a profession and predicted future skills of the profession.

In another exemplary implementation, the multi-dimensional skills model 405 is created for plural individuals and one position. In this implementation, the multi-dimensional skills model 405 is used to determine a respective score for each respective individual compared to the position. The scores may be used by an organization for comparing the plural individuals for the one position, e.g., when evaluating plural candidates for a job opening. The scores can thus be used to determine an optimal one of the individuals for the position.

FIG. 5 shows an example of generalizing a multi-dimensional skills model across plural professions in accordance with aspects of the present invention. As shown in FIG. 5, a multi-dimensional skills model 505a created for a first profession (e.g., Data Science) may be generalized to multi-dimensional skills models 505b, 505c, and 505d for other professions. In embodiments, the server 210 uses a transference layer of multi-dimensional skills models 510 to perform the generalization from one model (e.g., 505a) to another model (e.g., 505b). In embodiments, the transference layer of multi-dimensional skills models 510 includes transference mappings used to map skills in the taxonomy of the first profession to skills in the taxonomy of the second profession.

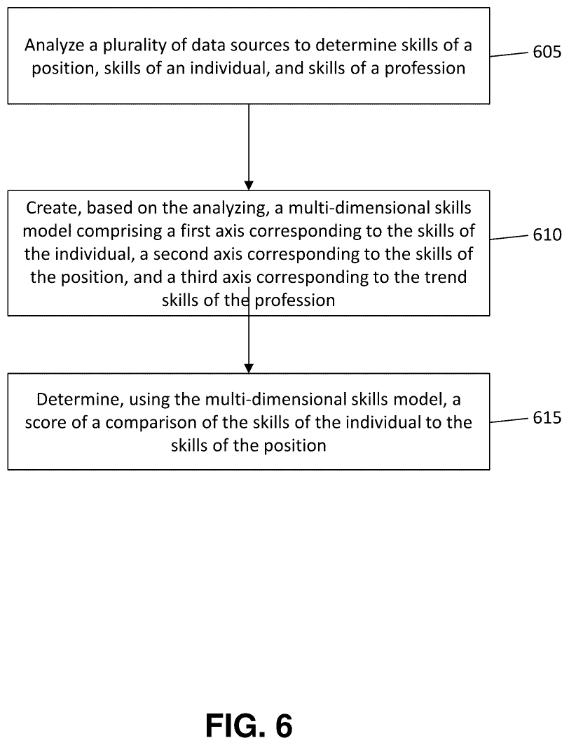

FIG. 6 shows a flowchart of an exemplary method in accordance with aspects of the present invention. Steps of the method may be carried out in the environment of FIG. 2 and are described with reference to elements depicted in FIG. 2.

At step 605, the system analyzes a plurality of data sources to determine skills of a position, skills of an individual, and skills of a profession. In embodiments, and as described with respect to FIG. 2, the analysis module 240 analyzes the data sources 225, 230, and 235.

At step 610, the system creates, based on the analyzing, a multi-dimensional skills model comprising a first axis corresponding to the skills of the individual, a second axis corresponding to the skills of the position, and a third axis corresponding to the trend skills of the profession. In embodiments, and as described with respect to FIG. 2, the modeling module 245 creates the multi-dimensional skills model.

At step 615, the system determines, using the multi-dimensional skills model, a score of a comparison of the skills of the individual to the skills of the position. In embodiments, and as described with respect to FIG. 2, the comparison module 250 generates the score. The score may be determined using different algorithms, such as Cohen's kappa, cosine similarity, or Euclidean distance based on k-means clustering. In one example, the score comprises a probability that the skills of the individual are fit for the position.

In embodiments, the method further comprises: determining a respective said score for each of plural individuals; and determining an optimum one of the plural individuals for the position based on the respective scores.

In embodiments of the method, the plurality of data sources comprise profession skills data sources, individual skills data sources, and profession trends data sources. The analyzing may comprise topic modeling and corpus linguistics. Moreover, the analyzing the trend skills of the profession may include performing times series forecasting, where the third axis corresponds to trend skills of the profession based on the time series forecasting.

In embodiments of the method, the skills of the position, the skills of the individual, and the trend skills of the profession comprise respective subsets of a taxonomy. In embodiments, the taxonomy comprises a hierarchical taxonomy.

In embodiments of the method, the multi-dimensional skills model comprises the skills of the position, the skills of the individual, and the trend skills of the profession mapped into a three-dimensional space defined by the first axis, the second axis, and the third axis.

In embodiments, the method further comprises generalizing the multi-dimensional skills model to another profession. The generalizing may be performed using a transference layer as described at FIG. 5.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing, by a processor set, a plurality of data sources to determine skills of a position, skills of an individual, and trend skills of a profession;
creating, by the processor set and based on the analyzing, a multi-dimensional skills model comprising a first axis corresponding to the skills of the individual, a second axis corresponding to the skills of the position, and a third axis corresponding to the trend skills of the profession; and
determining, by the processor set and using the multi-dimensional skills model, a score of a comparison of the skills of the individual to the skills of the position.

2. The computer-implemented method of claim 1, wherein the score comprises a probability that the skills of the individual are fit for the position.

3. The computer-implemented method of claim 1, further comprising:
determining a respective said score for each of a plurality of individuals; and
determining an optimum one of the plurality of individuals for the position based on the respective scores.

4. The computer-implemented method of claim 1, wherein the plurality of data sources comprise profession skills data sources, individual skills data sources, and profession trends data sources.

5. The computer-implemented method of claim 4, wherein the analyzing comprises topic modeling and corpus linguistics.

6. The computer-implemented method of claim 4, wherein:
the analyzing the trend skills of the profession includes performing times series forecasting; and
the third axis corresponds to trend skills of the profession based on the time series forecasting.

7. The computer-implemented method of claim 1, wherein the skills of the position, the skills of the individual, and the trend skills of the profession comprise respective subsets of a taxonomy.

8. The computer-implemented method of claim 7, wherein the taxonomy comprises a hierarchical taxonomy.

9. The computer-implemented method of claim 1, wherein the multi-dimensional skills model comprises the skills of the position, the skills of the individual, and the trend skills of the profession mapped into a three-dimensional space defined by the first axis, the second axis, and the third axis.

10. The computer-implemented method of claim 1, further comprising generalizing the multi-dimensional skills model to another profession.

11. A computer program product comprising one or more computer readable storage media having program instructions collectively stored on the one or more computer readable storage media, the program instructions executable to:
analyze, based on a taxonomy of skills, a plurality of data sources to determine skills of a position, skills of an individual, and trend skills of a profession;
create, based on the analyzing, a multi-dimensional skills model comprising a first axis corresponding to the skills of the individual, a second axis corresponding to the skills of the position, and a third axis corresponding to the trend skills of the profession; and
determine, using the multi-dimensional skills model, a score of a comparison of the skills of the individual to the skills of the position.

12. The computer program product computer program product of claim 11, wherein the score comprises a probability that the skills of the individual are fit for the position.

13. The computer program product of claim 11, further comprising:
determining a respective said score for each of plural individuals; and
determining an optimum one of the plural individuals for the position based on the respective scores.

14. The computer program product of claim 11, wherein:
the plurality of data sources comprise profession skills data sources, individual skills data sources, and profession trends data sources; and
the analyzing comprises topic modeling and corpus linguistics.

15. The computer program product of claim 11, wherein:
the analyzing the trend skills of the profession includes performing times series forecasting; and
the third axis corresponds to trend skills of the profession based on the time series forecasting.

16. A system comprising:
a processor set, one or more computer readable storage media, and program instructions collectively stored on the one or more computer readable storage media, the program instructions executable to:
analyze, based on a taxonomy of skills, a plurality of data sources to determine skills of a position, skills of an individual, and trend skills of a profession;
create, based on the analyzing, a multi-dimensional skills model comprising a first axis corresponding to the skills of the individual, a second axis corresponding to the skills of the position, and a third axis corresponding to the trend skills of the profession; and
determine, using the multi-dimensional skills model, a score of a comparison of the skills of the individual to the skills of the position.

17. The system of claim 16, wherein the score comprises a probability that the skills of the individual are fit for the position.

18. The system of claim 16, further comprising:
determining a respective said score for each of plural individuals; and
determining an optimum one of the plural individuals for the position based on the respective scores.

19. The system of claim 16, wherein:
the plurality of data sources comprise profession skills data sources, individual skills data sources, and profession trends data sources; and
the analyzing comprises topic modeling and corpus linguistics.

20. The system of claim 16, wherein:
the analyzing the trend skills of the profession includes performing times series forecasting; and
the third axis corresponds to trend skills of the profession based on the time series forecasting.
